(19) United States
(12) Patent Application Publication
(10) Pub. No.: US 2024/0062219 A1
(43) Pub. Date: Feb. 22, 2024

(54) GRANULAR TAXONOMY FOR CUSTOMER SUPPORT AUGMENTED WITH AI

(71) Applicant: Forethought Technologies, Inc., San Francisco, CA (US)

(72) Inventors: Sami Goche, San Francisco, CA (US); EJ Liao, Huntington Beach, CA (US); Jude Khouja, San Francisco, CA (US); Dev Sharma, San Francisco, CA (US); Yi Lu, Bellevue, WA (US); James Man, Brisbane, CA (US); Sambhav Galada, Fremont, CA (US); Carolyn Sun, Saratoga, CA (US); Holman Yuen, Chino Hills, CA (US); Sunny Kong, Portland, OR (US); Weitian Xing, Ottawa (CA); Antoine Nasr, San Francisco, CA (US); Dustin Kiselbach, Astoria, NY (US); Andrew Kim, Fremont, CA (US); Andrew Laird, Santa Clara, CA (US); Lewin Gan, San Francisco, CA (US); Nick Carter, San Francisco, CA (US); Salina Wu, Los Angeles, CA (US); Madeline Wu, San Francisco, CA (US); Jad Chamoun, San Francisco, CA (US); Deon Nicholas, Millbrae, CA (US)

(21) Appl. No.: 18/460,188

(22) Filed: Sep. 1, 2023

Related U.S. Application Data
(63) Continuation-in-part of application No. 17/682,537, filed on Feb. 28, 2022.
(60) Provisional application No. 63/155,449, filed on Mar. 2, 2021.
(60) Provisional application No. 63/403,054, filed on Sep. 1, 2022.

(51) Int. Cl. G06Q 30/015; G06N 20/00

(52) U.S. Cl. CPC G06Q 30/015; G06N 20/00

(57) ABSTRACT

A computer-implemented method for augmenting customer support is disclosed in which a granular taxonomy is formed to classify tickets based on customer issue topic. A dashboard and user interface of performance metrics may be generated for the topics in the taxonomy. Recommendations may also be generated to aid servicing customer support issues for topics in the taxonomy. This may include generating information to aid in determining topics for generating automated responses or generating recommended answers for particular topics. In some implementations, an archive of historic tickets is used to generate training data for a machine learning model to classify tickets.

### CROSS-REFERENCE TO RELATED APPLICATIONS

The application is a continuation-in-part of U.S. patent application Ser. No. 17/682,537, which claims priority under 35 U.S.C. § 119, to U.S. Provisional Patent Application No. 63/155,449, filed Mar. 2, 2021 and entitled “Customer Service Helpdesk Augmented with AI”, the entirety of which is hereby incorporated by reference.

This application also claims priority to U.S. Provisional Patent Application No. 63/403,054, filed Sep. 1, 2022 and entitled “Granular Taxonomy for customer Support Augmented with AI, the entirety of which is hereby incorporated by reference.

### FIELD OF THE INVENTION

The present disclosure generally relates to servicing customer support issues, such as responding to questions or complaints during a lifecycle of a customer support issue.

### BACKGROUND

Customer support service is an important aspect of many businesses. For example, there are a variety of customer support applications to address customer service support issues. As one illustration, a customer service helpdesk may have a set of human agents who use text messages to service customer support issues. There are a variety of Customer Relationship Management (CRM) and helpdesk-related software tools, such as SalesForce® or Zendesk®.

Customer support issues may be assigned a ticket that is served by available human agents over the lifecycle of the ticket. The lifecycle of resolving the customer support issue(s) associated with a ticket may include one or more customer questions and one or more answers made by an agent in response to customer question(s). To address common support questions, the human agents may have available to them macros and templates in SalesForce® or templates in Zendesk® as examples. Macros and templates work well for generating information to respond to routine requests for information, such as if a customer asks, “Do you offer refunds?” However, there are some types of more complicated or non-routine questions for which there may be no macro or template.

Human agents may have available to them other data sources spread across an organization (e.g., Confluence®, WordPress®, Nanorep®, Readmeio®, JIRA®, Guru®, Knowledge Bases, etc.). However, while an institution may have a lot of institutional knowledge to aid human agents, there may be practical difficulties in training agents to use all the institutional knowledge that is potentially available to aid in responding to tickets. For example, conventionally, a human agent may end up doing a manual search of the institutional knowledge. However, an agent may waste time in unproductive searches of the institutional knowledge.

Typically, a human expert makes decisions on how to label and route tickets, which is a resource intensive task. There is also a delay associated with this process because incoming tickets have to wait in a queue for a human expert to make labeling and routing decisions.

However, there are substantial training and labor costs to have a large pool of highly trained human agents available to service customer issues. There are also labor costs associated with having human experts making decisions about how to label and route tickets. But in addition to labor costs, there are other issues in terms of the frustration customers experience if there is a long delay in responding to their queries.

In addition to other issues, it has often been impractical in conventional techniques to have more than a small number of customer issue topics as categories. That is, conventionally tickets are categorized into a small number of categories (e.g., 15) for handling by agents.

### SUMMARY

A system and method for augmenting customer support is disclosed. Customer support tickets are classified into tickets that can be automatically responded to within a desired confidence level and tickets requiring assistance of a human agent. In some implementations, additional support services to assist agents to respond to customer tickets may be included. In some implementations, an archive of historic tickets is used to generate training data for a machine learning model to classify tickets. An archive of historic tickets may also be used to identify macro template answers. The identified macro template answers can be used to generate automatic responses to incoming tickets.

An example of a method includes receiving customer support tickets associated with a helpdesk. Classification is performed by a trained machine learning model to classify the received customer support tickets into tickets to be responded to automatically and customer support tickets requiring a human agent to respond. The trained machine learning model is trained to identify whether a customer support ticket has a question that can be solved by responding with a template macro answer from a set of template macro answers.

In some implementations, a set of macro template answers are identified from historic tickets having variations in the wording of answers. A machine learning model is trained to classify customer support tickets associated with a helpdesk into tickets capable of being automatically responded to by a macro template answer, from the set of macro template answers, exceeding a selected threshold confidence level. The trained machine learning model is used to classify customer support tickets incapable of being automatically responded to. Those tickets exceeding the selected confidence level are handled by a human agent.

In one implementation, a granular taxonomy is discovered from historical customer support tickets. The granular taxonomy is identified in training a classifier. In one implementation, customer support tickets associated with a helpdesk are ingested. The ingest customer support tickets may, for example, be historical customer support tickets from a selected time interval. The ingested customer support tickets may be filtered to filter at least one of noisy and irrelevant tickets. The filtered customer support tickets may be processed to convert unstructured ticket data to structured data to form tickets with structured data. The resulting tickets with structured data may be clustered. The clusters may be utilized to label the tickets to form a weakly supervised training data. A classifier may be trained on the weakly supervised training data to classify customer support tickets into topics of a granular taxonomy. In some implementations, the granular taxonomy may be used to identify topics (intents) that are candidates for generating automatic responses.

It should be understood, however, that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a block diagram illustrating a customer service support environment in accordance with an implementation.

FIG. 2A is a block diagram illustrating a module for using AI to augment customer support agents in accordance with an implementation.

FIG. 2B is a block diagram of a server-based implementation.

FIG. 3 is a block diagram of a portion of a ML system in accordance with an implementation.

FIG. 4 is a flow chart of a method of servicing tickets in accordance with an implementation.

FIG. 5 is a flow chart of a method of automatically generating a templet answer to an incoming question in accordance with an implementation.

FIG. 6 illustrates an example of ML pipeline in accordance with an implementation.

FIG. 7 illustrates aspects of using supervised learning to solve macros in accordance with an implementation.

FIG. 8 is a flow chart of a method of generating macro template answer codes in accordance with an implementation.

FIG. 9 illustrates an example of a method of identifying macro template answers and also initiating a workflow task in accordance with an implementation.

FIG. 10 illustrates an example of a method of training a ML model for triaging the routing of tickets in accordance with an implementation.

FIG. 11 illustrates a method of performing triaging in the routing of tickets in accordance with an implementation.

FIG. 12 illustrates a method of identifying knowledge-based articles to respond to a question in accordance with an implementation.

FIG. 13 illustrates a user interface to define a custom intent and support intent workflows in accordance with an implementation.

FIG. 14 illustrates an example of a discovery module having a trained classifier to identify topics of customer support tickets based on a taxonomy in accordance with an implementation.

FIG. 15 is a flow chart of an example method for using the trained classifier in accordance with an implementation.

FIG. 16 is a flow chart of an example method for training a classifier in accordance with an implementation.

FIG. 17 is a flow chart of an example method of filtering noise from ticket data in accordance with an implementation.

FIG. 18 is a flow chart of an example method for generating labels in accordance with an implementation.

FIG. 19 is a flow chart of an example method of training a classifier based on labelled ticket data in accordance with an implementation.

FIG. 20 illustrates an example of performance metrics for predicted topics in accordance with an implementation.

FIG. 21 illustrates an example of a user interface for a pull queue of an agent in accordance with an implementation.

FIG. 22 illustrates an example of a dashboard in accordance with an implementation.

FIG. 23 illustrates a topics user interface in accordance with an implementation.

FIG. 24 illustrates a user interface showing a topic and example tickets.

FIG. 25 illustrates a user interface for building a custom workflow in accordance with an implementation.

FIG. 26 illustrates a user interface for displaying an issue list in accordance with an implementation.

### DETAILED DESCRIPTION

The present disclosure describes systems and methods for aiding human agents to service customer support issues.

Example System Environment

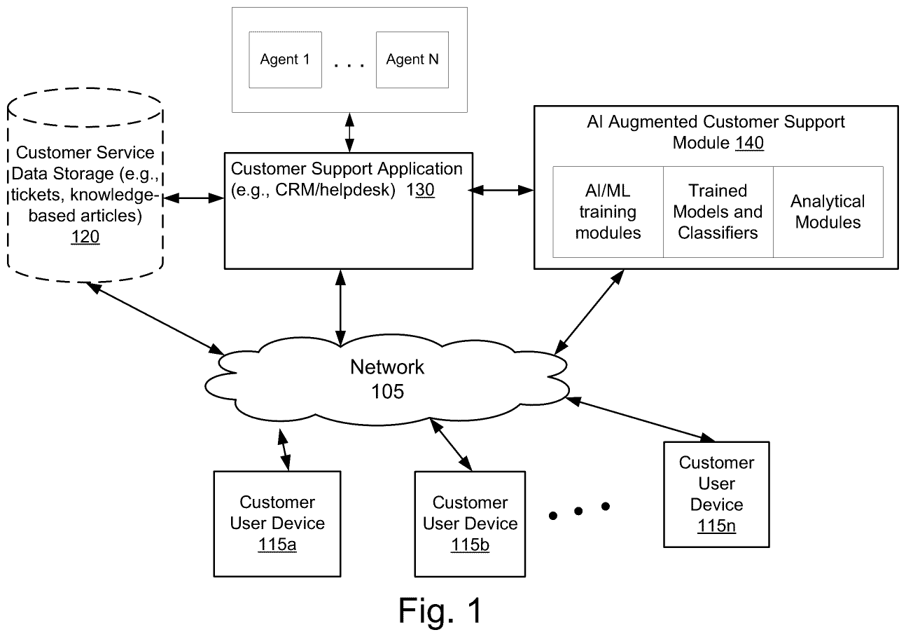

FIG. 1 is a high-level block diagram illustrating a customer support environment in accordance with an implementation. The customer support may be provided in a variety of different industries such as support for software applications but more generally be applied to a variety of different industries in which customers have questions that are traditionally answered by human agents. Individual customers have respective customer user devices 115a to 115n that access a network 105, where the network may include the Internet.

A customer support application 130 (e.g., a CRM or a helpdesk) may run on its own server or be implemented on the cloud. The customer support application 130 may, for example, be responsible for receiving customer support queries from individual customer user devices. For example, customer service queries may enter an input queue for routing to individual customer support agents. This may, for example, be implemented using a ticketing paradigm in which a ticket dealing with a customer support issue has at least one question, leading to at least one answer being generated in response during the lifecycle of a ticket. A user interface may, for example, support chat messaging with an agent to resolve a customer support issue, where there may be a pool of agents 1 to N. In a ticketing paradigm, there are Question/Answer pairs for a customer support issue corresponding to questions and corresponding answers.

A database 120 stores customer support data. This may include an archive of historical tickets, that includes the Question/Answer pairs as well as other information associated with the lifecycle of a ticket. The database 120 may also include links or copies of information used by agents to respond to queries, such as knowledge-based articles.

An Artificial Intelligence (AI) augmented customer support module 140 may be implemented in different ways, such as being executed on its own server, being operated on the cloud, or executing on a server of the customer support application. The AI augmented customer support module 140 includes at least one machine learning (ML) model to aid in servicing tickets.

During at least an initial setup time, the AI augmented customer support module 140 has access to data storage 120 to access historical customer support data, including historical tickets. The AI augmented customer service module 140 may, for example, have individual AI/ML training modules, trained models and classifiers, and customer service analytical modules. The AI augmented customer service module 140 may, for example, use natural language understanding (NLU) to aid in interpreting customer issues in tickets.

The AI augmented customer support module 140 may support one or more functions, such as 1) automatically solving at least a portion of routine customer service support questions; 2) aiding in automatically routing customer service tickets to individual agents, which may include performing a form of triage in which customer tickets in danger of escalation are identified for special service (e.g., to a manager or someone with training in handling escalations); and 3) assisting human agents to formulate responses to complicated questions by, for example, providing suggestions or examples a human agent may select and/or customize.

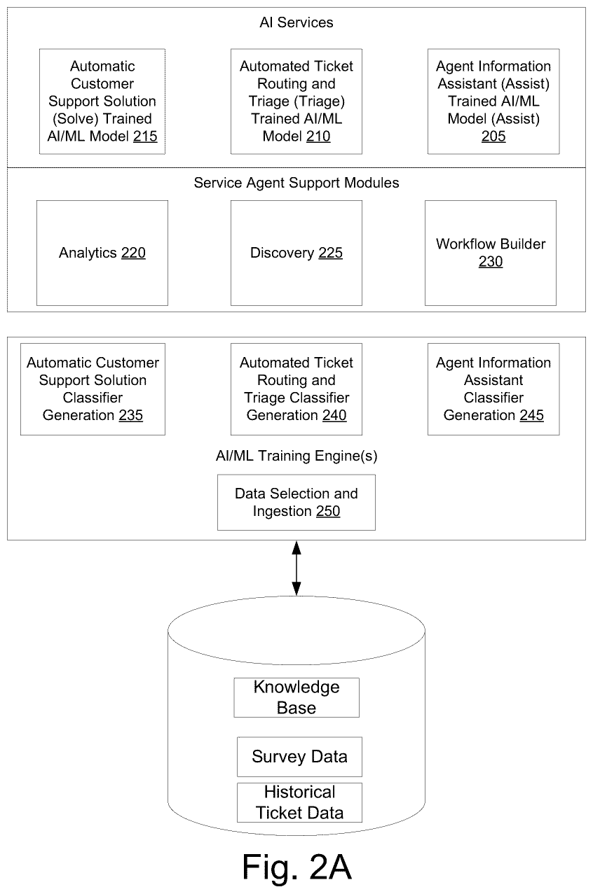

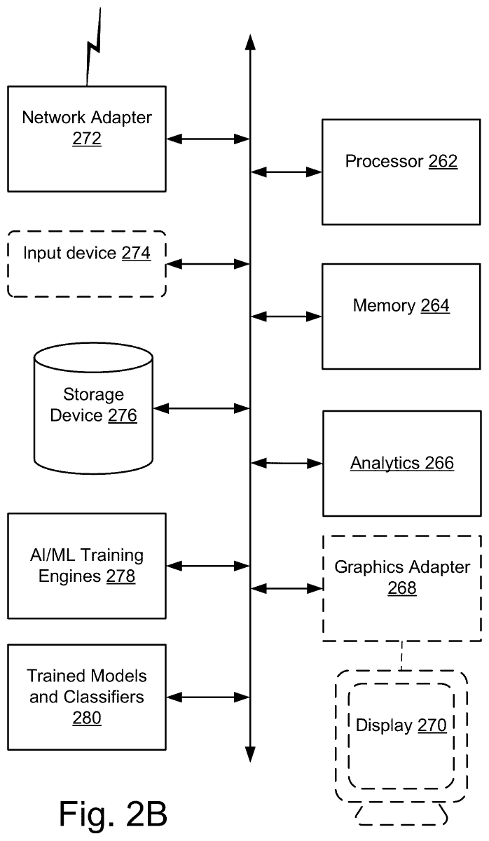

FIG. 2A illustrates an example of functional modules in accordance with an implementation. AI/ML services may include an agent information assistant (an “Assist Module”) 205 to generate information to assist a human agent to respond to a customer question, a ticket routing and triage assistant (a “Triage Module”) 210 to aid in routing tickets to human agents, and an automatic customer support solution module (a “Solve Module”) 215 to automatically generate response solutions for routine questions.

Examples of non-AI services may include an analytics module 220, a discovery module 225, and a workflow builder module 230.

AI/ML training engines may include support for using AI/ML techniques, such as generating labelled data sets or using weakly supervised learning to generate datasets to generate classifiers. The raw data ingested training may include, for example, historical ticket data, survey data, and knowledge base information. A data selection and ingestion module 250 may be provided to select and ingest data. In some implementations, additional functions may include removing confidential information from ingested data to protect data privacy/confidentiality.

Classifiers may be created to predict outcomes based on a feature dataset extracted from incoming tickets. For example, AI/ML techniques may be used to, for example, create a classifier 235 to classify incoming tickets into classes of questions that can be reliably mapped to a pre-approved answer. AI/ML techniques may be used to classify 240 tickets for routing to agents, including identifying a class of incoming tickets having a high likelihood of escalation. AI/ML techniques may also be created to generate 245 information to assist agents, such as generating suggested answers or suggested answer portions.

FIG. 2B illustrates a server-based implementation in which individual components are communicatively coupled to each other. A processor 262, memory 264, network adapter, input device 274, storage device 276, graphics adapter 268, and display 270 may be communicatively coupled by a communication bus. Additional modules may include, for example, computer program instructions stored on memory units to implement analytics functions 266, AI/ML training engines 278, and trained models and classifiers 280.

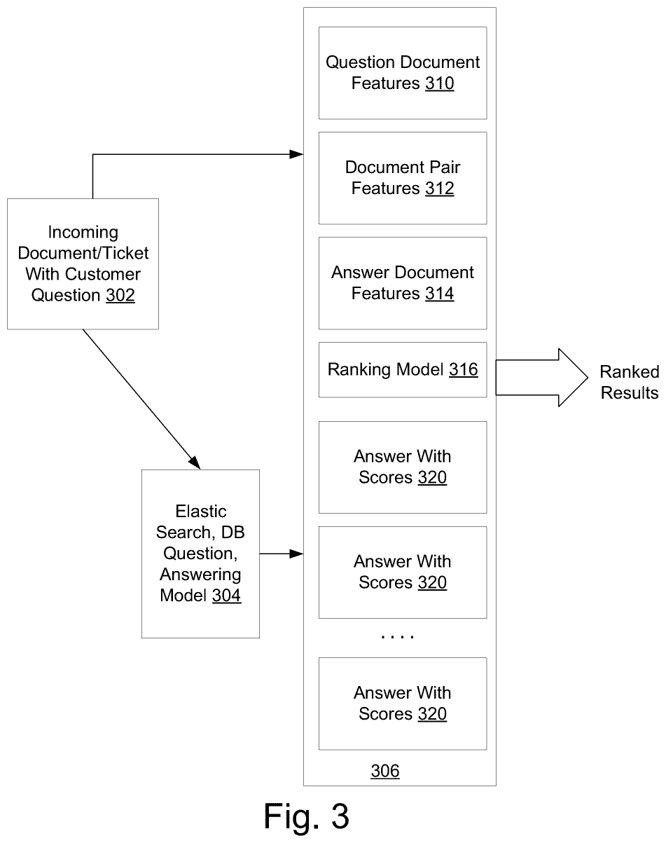

FIG. 3 illustrates an example of a portion of a system 306 in which an incoming ticket 302 is received that has a customer question. The incoming question can be analyzed for question document features 310, document pair features 312, answer document features 314, and can be used to identify answers with scores 320 according to a ranking model 316. For example, an incoming ticket 302 can be analyzed to determine if a solution to a customer question can be automatically responded to using a pre-approved answer within a desired threshold level of accuracy. For more complicated questions, the incoming question can be analyzed to generate suggested possible answers for human agents to consider in formulating an answer to a customer question. Additional analysis may also be performed to identify knowledge articles for agents to service tickets. Additional support may be provided by module 304, which supports elastic search, database questions, and an answering model.

### Example Solve Module

An example of the Solve module is now described regarding automatically generating responses to customer issues. A wide variety of data might be potentially ingested and used to generate automatic responses. This includes a history of tickets and chats and whatever else a company may potentially have regarding CRMs/helpdesks like Zendesk® or Salesforce®. In addition, the ingested data may include stores of any other data sources that a company has for resolving tickets. This may include things like confluence document, Jira, WordPress, etc. This can generally be described in terms of knowledge base documents associated with a history of tickets.

The history of tickets is a valuable resource for training an AI engine to mimic the way human agents respond to common questions. Historical tickets track the lifecycle of responding to a support question. As a result, they include a history of the initial question, answers by agents, and chat information associated with the ticket.

Human agents are typically trained to respond to common situations with variations of standard, pre-approved responses. For example, human agents often respond to simple questions about certain classes of software questions by suggesting a user check their browser type or check that they are using the most current version of a software application.

Support managers may, for example, provide human agents with training on suggested, pre-approved answers for commonly asked questions. However, in practice, individual agents may customize the suggested answers, such as making minor tweaks to suggested answers.

The pre-approved answers may, in some cases, be implemented as macros/templates that agents insert into answers and edit to generate answers to common questions. For example, some helpdesk software solutions support an agent clicking a button to apply a macro command that inserts template text in an answer. The agent then slightly modifies the text, such as by filling in fields, making minor tweaks to language, etc.

There are several technical concerns associated with automatically generating responses to common questions using the macros/template a company has to respond to routine questions. The ML model needs to recognize when a customer issue falls into one of a large number of different buckets and respond with the appropriate pre-approved macro/template response with a desired level of accuracy.

In one implementation, an algorithm is used to construct a labeled dataset that allows the problem to be turned into a supervised learning problem. In one implementation, the data associated with historic tickets is ingested. There may, for example, be a list of macros/template answers that is available that is ingested through the CRM. For example, a CRM may support using a larger number, K, of macros. For example, there may be hundreds of macros to generate text for answers. As an example, suppose that K=500 so that there are 500 macros for common questions.

However, while in this example there are 500 macros for common questions, the historic tickets may include numerous variations in macro answers. In one implementation, tickets having answers based on a common macro are identified based on a longest common subsequence. In a longest common subsequence algorithm, subsequent words in the sequence, (though they might not necessarily be consecutive), show up in an order. For example, there might be a word inserted in between two or three words, a word added or removed, etc. This is a form of edit distance algorithm in that an ML algorithm may compare each answer to every single one of the 500 macros in this example of 500 macros. The algorithm may look at the ratio of how long a subsequence is relative to the length of the answer and the length of the macro. Thresholds may be used to assure that there is a high confidence that a particular answer was generated from a particular macro and not from another macro. Another way this can be viewed, is that for a single question in the historic database, a determination is made of which macro the corresponding answer was most likely generated from. Threshold values may be selected so that there is a high confidence level that a given answer was generated by a particular macro rather than from other macros. The threshold value may also be selected to prevent misidentifying custom answers (those not generated from a macro).

Thus, a data set is formed in which a large number of historic tickets have a question and (to a desired threshold of accuracy) have an associated macro answer. Thus, we end up with a supervised learning data set upon which classification can be run. A multi-class model can be run on top of the resulting data set. As an example, a trained model may be based on BERT, XLNet (a BERT-like model), or other transformer-based machine learning techniques for natural language processing pre-training.

Thus, the model may be trained to identify a macro to answer a common question. For example, the trained model may identify the ID of the macro that should be applied. However, a confidence level may be selected to ensure there is a high reliability in selecting an appropriate macro. For example, a threshold accuracy, such as 95%, may be selected. In some implementations, the threshold level of accuracy is adjustable by, for example, a manager.

This is a classification problem in that if a high threshold accuracy is selected, there is more accuracy in the classification, which means that it's more likely the correct macro is selected. However, selecting a high threshold accuracy means that a smaller percentage of incoming tickets can be automatically responded to. In some implementations, a manager or other authorized entity, such as a support administrator, can select or adjust the threshold percentages for prediction.

The classification performed by the trained ML model may be viewed as a form of intent detection in terms of predicting the intent of the user's question, and identifying which bucket the issue in the ticket falls under regarding a macro that can be applied.

Workflow Builder

In some implementations, a support manager may use an identification of a macro ID to configure specific workflows. For example, suppose that classification of an incoming question returns a macro ID for a refund (a refund macro). In this example, a workflow manager may include a confirmation email to confirm that a customer desires a refund. Or as another example, a macro may automatically generate a customer satisfaction survey to help identify why a refund was requested. More generally, a support manager may support a configurable set of options in response to receiving a macro ID. For example, in response to a refund macro, a confirmation email could be sent to the customer, an email to a client could be sent giving the client options for a refund (e.g., a full refund, a credit for other products or services), a customer satisfaction survey sent, etc.

Thus, in addition to automatically generating macro answers to questions, one or more workflow steps may also be automatically generated for a macro.

Automatic Identification of Knowledge-Based Information

In some implementations, various approaches may be used to automatically identify appropriate knowledge articles to respond to tickets. This can be performed as part of the Assist Module to aid agents to identify knowledge articles to respond to tickets. However, more generally, automatic identification of knowledge-based information may be performed in the Solve Module to automatically generate links to knowledge-based articles, copies of knowledge-based articles, or relevant paragraphs of knowledge based articles as part of an automatically generated answer to a common question.

One way to automatically identify knowledge-based information is to use a form of semantic searching for information retrieval to retrieve knowledge articles from a knowledge database associated with a CRM/helpdesk. However, another way is to perform a form of classification on top of historical tickets to look for answers that contain links to knowledge articles. That is, a knowledge article link can be identified that corresponds to an answer for a question. In effect, an additional form of supervised learning is performed in which there is a data set with questions and corresponding answers with links to a knowledge article. This is a data set that can be used to train a classifier. Thus, in response to an incoming question, a knowledge article that's responsive to the question is identified. The knowledge article can be split into paragraphs and the best paragraph or paragraphs returned. For example, the best paragraph(s) may be returned with word spans highlighted that are likely to be relevant to the question.

The highlighting of text may be based on a BERT model trained on the Stanford Question Answer Dataset (SQuAD). Other various optimizations may be performed in some implementations. One example of an optimization is called tensor RT, which is an Nvidia® hardware optimization.

In some implementations, elastic search techniques, such as BM 25 may be used to generate a ranking or scoring function. As other examples, similarities may be identified based on Google natural questions.

### Example Triage Module

A ticket covers the entire lifecycle of an issue. A dataset of historic tickets would conventionally be manually labelled for routing to agents. For example, a ticket might include fields for category and subcategory. It may also include fields identifying the queue the ticket was sent to. In some cases, the agent who answered the ticket may be included. The priority level associated with the ticket may also be included.

In one implementation, the ML system predicts the category and subcategory. The category and subcategory may determine, for example, a department or a subset of agents who can solve a ticket. For example, human agents may have different levels of training and experience. Depending on the labeling system, a priority level can be a particular type of sub-category. An escalation risk can be another example of a type of subcategory that determines who handles the agent. For example, a ticket that is predicted to be an escalation risk may be assigned to a manager or an agent with additional training or experience handling escalations. Depending on the labeling system, there may also be categories or sub-categories for spam (or suspected spam).

The Triage module may auto-tag based on predicted category/sub-category and route issues based on the category/subcategory. The Triage module may be trained on historic ticket data. The historic ticket data has questions and label information on category subcategory, and priority that can be collected as a data set upon which multi class classification models can be trained on using, for example, BERT or XLNet. This produces a probability distribution over all the categories and subcategories. As an illustrative example, if a confidence level (e.g., a threshold percentage) exceeds a selected threshold, the category/subcategory may be sent back to the CRM (e.g., Zendesk® or Salesforce®).

Various optimizations may be performed. One example of an optimization is data augmentation, which may include back translation. In back translation, new examples may be generated by translating back and forth between languages. For example, an English language example may be translated into Chinese and then translated back into English to create a new example. The new example is basically a paraphrasing and would have the same label. The back translation can be performed more than once. It may also be performed through multiple languages (e.g., English-French-English, English-German-English).

Another optimization for data augmentation includes unsupervised data augmentation. For example, there are augmentation techniques based on minimizing a KL divergence comparison.

The use of data augmentation techniques like back translation means that there is more training data to train models on. Having more training data is useful for dealing with the situation in which there is only limited amount of manually labelled training data. Such a situation may occur, for example, if a company recently changed its taxonomy for categories/subcategories.

One benefit of automating the identification of category/subcategory/priority level is that it facilitates routing. It avoids tickets waiting in a general queue for manual category/subcategory/priority entry of label information by a support agent. It also avoids the expense of manual labeling by a support agent.

The ML model can also be trained to make predictions of escalation, where escalation is the process of passing on tickets from a support agent to more experienced and knowledgeable personnel in the company, such as managers and supervisors, to resolve issues of customers that the previous agent failed to address.

For example, the model may identify an actual escalation in the sense of a ticket needing a manager or a skilled agent to handle the ticket. But more generally, it could identify a level of rising escalation risk (e.g., a risk of rising customer dissatisfaction).

A prediction of escalation can be based on the text of the ticket as well as other parameters, such as how long it's been since an agent answered on a thread, how many agents did a question/ticket cycle through, etc. In some implementations, another source of information for training the ML model to predict the risk of escalation may be based, in part, on customer satisfaction surveys. For example, for every ticket that's resolved, a customer survey may be sent out to the customer asking them to rate the support they received. The customer survey data may be used as a proxy for the risk of an escalation. The escalation model may be based on BERT or XLNet, trained on a secondary data set that is formed from a history of filled out survey data.

### Example Assist Module

In one implementation, the Assist module aids human agents to generate responses. The agents may access macro template answers, the knowledge base of articles, such as WordPress, confluence Google docs, etc. Additionally, in one implementation, the Assist module has a best ticket function to identify a ticket or tickets in the historic database that may be relevant to an incoming question. This best ticket function may be used to provide options for the agent to craft an answer. In one implementation, an answer from a past ticket is identified as a recommended answer to a new incoming ticket so that the support agent can use all or part of the recommended answer and/or revise the recommended answer. In some implementations, a one-click answer functionality is supported for an agent to select a recommended answer.

In one implementation, dense passage retrieval techniques are used to identify a best answer. Dense passage retrieval techniques are described in the paper, Dense Passage Retrieval for Open-Domain Question Answering, Vladimir Karpukhin, Barlas O\check{g}uz, Sewon Min, Patrick Lewis, Ledell Wu, Sergey Edunov, Danqi Chen, Wen-tau Yih, arXiv:2004.04906 [cs.CL], the contents of which are hereby incorporated by reference. Open-domain question answering relies on efficient passage retrieval to select candidate contexts, where traditional sparse vector space models, such as TF-IDF or BM25, are the de facto method. Embeddings are learned from a small number of questions and passages by a dual-encoder framework.

Some of the problems with identifying a best ticket to generate a suggested possible answer to a question is that there may be a large database of historic tickets from which to select potentially relevant tickets. Additionally, for a given issue (e.g., video conference quality for a video conferencing service), customers can have many variations in the way they word their question. The customer can ask basically the same exact question using very different words. Additionally, different questions may use the same keywords. For example, in a video conferencing application helpdesk, different customer questions may include similar keywords for slightly different issues. The combination of these factors means that traditionally it was hard to use an archive of historic tickets as a resource to answer questions. For example, simplistically using keywords from a ticket to look for relevant tickets in an archive of historic tickets might generate a large number of tickets that may not necessarily be useful for an agent. There are a variety of practical computational problems trying to use old tickets as a resource to aid agents to craft responses. Many techniques of creating a labelled data set would be too computationally expensive or have other problems in generating useful information for agents.

In one implementation using a dual encoder framework, there is an encoder for a question, and an encoder for a candidate answer. Each of them produces an embedding. There are outputs and embeddings, there is additional dot product co-sign similarity or a linear layer on top of that as a piece in the middle. Both pieces are trained simultaneously to train an encoder for the question and an encoder for the answer, as well as the layer in-between. There may, for example, be a loss minimization function used in the training.

Each encoder piece is effectively being trained with knowledge of the other encoder piece. So they learn to produce an embedding that's answerable. The embedding is stored in the database. At run time, the model itself is one layer, not a huge number of parameters, and the inputs are embeddings, which are comparatively small in terms of storage and computational resources. This permits candidate answer selection batches to be run in real time with low computational effort.

In other words, embeddings are learned using a dual encoder framework. The training of the encoder may be done so that the dot-product similarities become a good ranking function for retrieval. There is a pre-computing of embeddings, based on training the two encoders jointly so that they are both aware of each other.

Auto-Suggestion of Answers

In some implementations, an agent is provided with auto-suggestions for at least partially completing a response answer. For example, typing their response, the system suggests a selection of words having a threshold confidence level for a specific completion. This may correspond to a text for the next X words, where X might be between 10, 15, or 20 words, as an example, with the total number of words being selected may be limited to maintain a high confidence level. The auto-suggestion may be based on the history of tickets as an agent is typing their answer. It may also be customized for individual agents. The ML model may, for example, be based on a GPT2 model.

In some implementations, historical tickets are tokenized to put in markers at the beginning of the question, the beginning of the subject of the description, the beginning of the answer, or at any other location where a token may help to identify portions of questions and corresponding portions of an answer. At the end of the whole ticket, additional special markers are placed. The marked tickets are fed into GPT2. The model is trained to generate word prompts based on the entire question as well as anything that the agent has typed so far in their answer.

In some implementations, further customizations may be performed at a company level and/or an agent level. That is, the training can be specific for questions that a company often gets. For example, at company Alpha Bravo, an agent may text: “Thank you for contacting Alpha Bravo. My name is Alan. I'd be happy to assist you.”

Customization can also be performed at an agent level. For example, if at the beginning of the answer, it is agent 7 that is answering, then the agent 7 answer suggestions may be customized based on the way agent 7 uses language.

1-Click Agent Assistance

In some implementations, the agent is provided with auto-suggestions that may be implemented by the agent with minimal agent effort to accept a suggestion, e.g., with 1-click as one example. The details of the user answer may be chosen to make suggestions with a high reliability and to make it easy for agents to enter or otherwise approve the suggested answers.

### Analytics Module

The analytics module may support a variety of analytical functions to look at data, filter data, and track performance. This may include generating visualizations on the data, such as metrics about tickets automatically solved, agents given assistance, triage routing performed, etc. Analytics helps to provide an insight into how the ML is helping to service tickets.

### Privacy/Confidentiality Protection

The processing of information from the historic ticket database may be performed to preserve privacy/confidentiality by, for example, removing confidential information from the questions/answers. That is, the method described may be implemented to be compliant with personal data security protection protocols.

### Customer Feedback/Agent Feedback

In some implementations, customers can input feedback (e.g., thumbs up/thumbs down) regarding the support they received in addition to answering surveys. The customer feedback may also be used to aid in optimizing algorithms or as information to aid in determining an escalation risk. Similarly, in some implementations, agents may provide feedback on how useful suggested answers have been to them.

### Discovery Module

In one implementation, a discovery module provides insights to support managers. This may include generating metrics of overall customer satisfaction. In some implementations, a support manager can drill deeper and segment by the type of ticket. Additionally, another aspect is identifying knowledge gaps, or document documentation gaps. For example, some of these categories or subcategories of tickets may never receive a document assigned a high score by the ML model. If so, this may indicate a gap of knowledge articles. As another example, the system may detect similar questions that are not getting solved by macros. In that case, an insight may be generated to create a macro to solve that type of question. In some implementations, the macro may be automatically generated. Such as by picking a representative answer. As an example, in one implementation, there is a clustering of questions and then picking of a representative macro or generating the right macro.

High Level Flow Chart of Overall Method

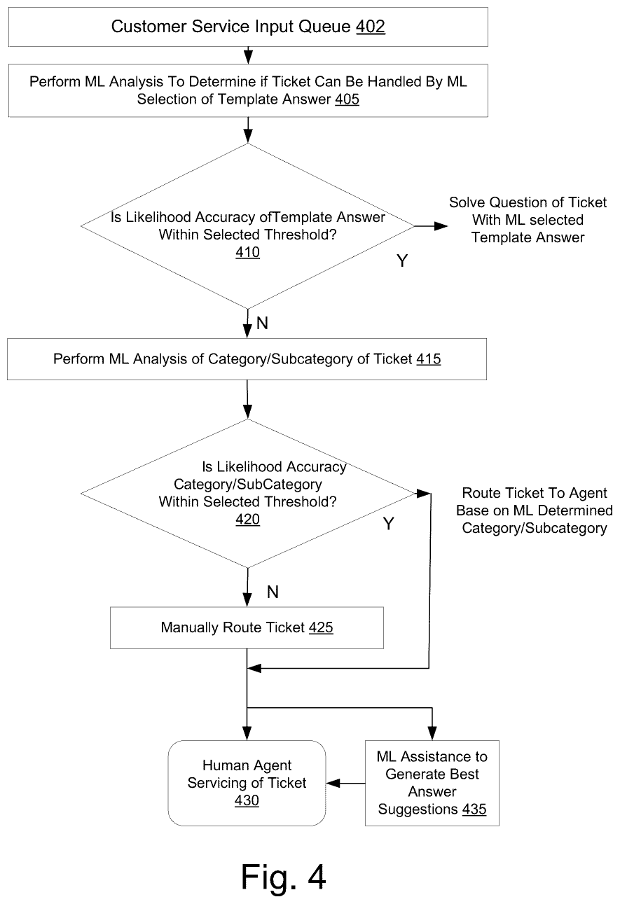

FIG. 4 is a flow chart in accordance to an example. A customer question is received at an input queue in block 402. In block 405, an analysis is performed to determine if a ticket's question can be handled by a ML selection of a template answer.

In decision block 410, a decision is made whether to handle a question with a template answer based on whether a likelihood that a template answer exceeds a selected threshold of accuracy (e.g., above 90%). If the answer is yes, the ticket is solved with an AI/ML selected template answer. If the answer is no, then the question of the ticket is routed to a human agent to resolve.

In block 415, ML analysis is performed of a ticket to identify a category/subcategory for routing a ticket. This may include identifying whether a ticket is likely to be one in which escalation will happen, e.g., predicting a risk of escalation.

In block 420, the likelihood of an accurate category/subcategory determination may be compared with a selected threshold. For example, if the accuracy for a category/subcategory/priority exceeds a threshold percentage, the ticket may be routed by category/subcategory/priority. For example, some human agents may have more training or experience handling different issues. Some agents may also have more training or experience dealing with an escalation scenario. If the category/subcategory determination exceeds a desired accuracy, the ticket is automatically routed by the AI/ML determined category/subcategory. If not, the ticket may be manually routed.

In block 430, a human agent services the question of a ticket. However, as illustrated in block 435, additional ML assistance may be provided to generate answer recommendations, suggested answers, or provide knowledge resources to aid an agent to formulate a response (e.g., suggest knowledge articles or paragraphs of knowledge articles).

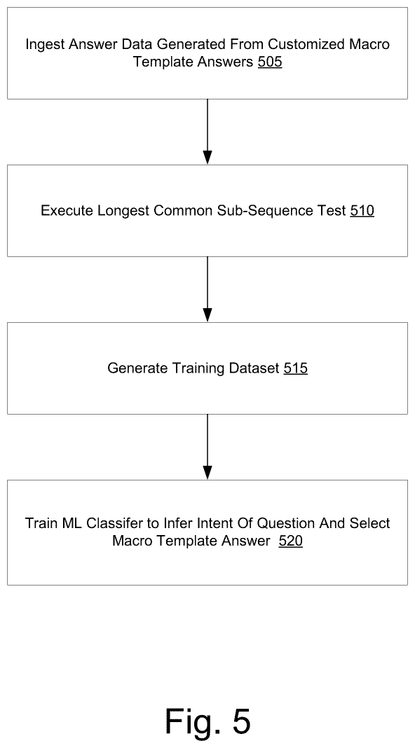

FIG. 5 illustrates a method of determining template answers in accordance with an implementation. In many helpdesk scenarios, human agents are trained to use pre-approved template answer language to address common questions, such as pre-approved phrases and sentences that can be customized. Thus, a collection of historical tickets will have a large number of tickets that include variations of template answer phrases/sentences. In block 505, historic ticket data is ingested, where the historic ticket data includes questions and answers in which at least some of the answers may be based on pre-approved (template) answers. A list of the pre-approved answer language may be provided.

In block 510, a longest common sub-sequence test is performed on the tickets. This permits tickets to be identified that have answers that are a variation of a given macro template answer. More precisely, for a certain fraction of tickets, the ticket answer can be identified as having been likely generated from a particular macro within a desired threshold level of accuracy.

In block 515, a training dataset is generated in which the dataset has questions and associated macro answers identified from the analysis of block 510.

The generated dataset may be used to train a ML classifier to infer intent of a new question and select a macro template answer. That is, a ML classifier can be trained based on questions and answers in the tickets to infer (predict) the user's intention and identify template answers to automatically generate a response.

It should be noted the trained ML classifier doesn't have to automatically respond to all incoming questions. An accuracy level of the prediction may be selected to be a desired high threshold level.

Additional Flow Charts

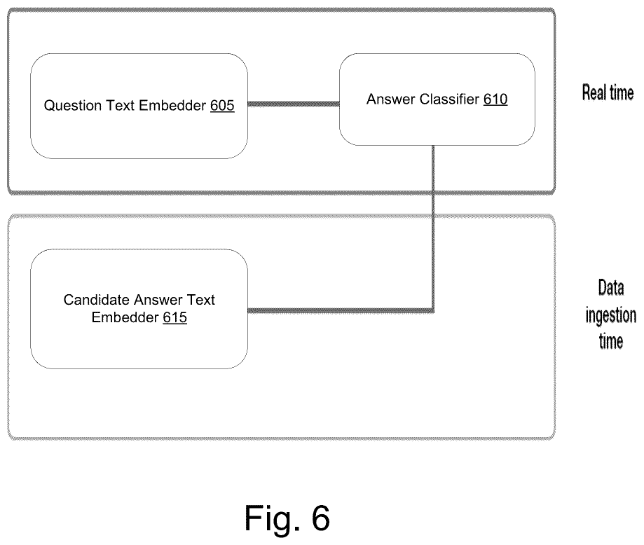

As illustrated in FIG. 6, in one implementation, the ML pipeline may include a question text embedder, a candidate answer text embedder, and an answer classifier. As previously discussed, the training process of question encoders, answer encoders, and embeddings may be performed to facilitate generating candidate answer text in real time to assist agents.

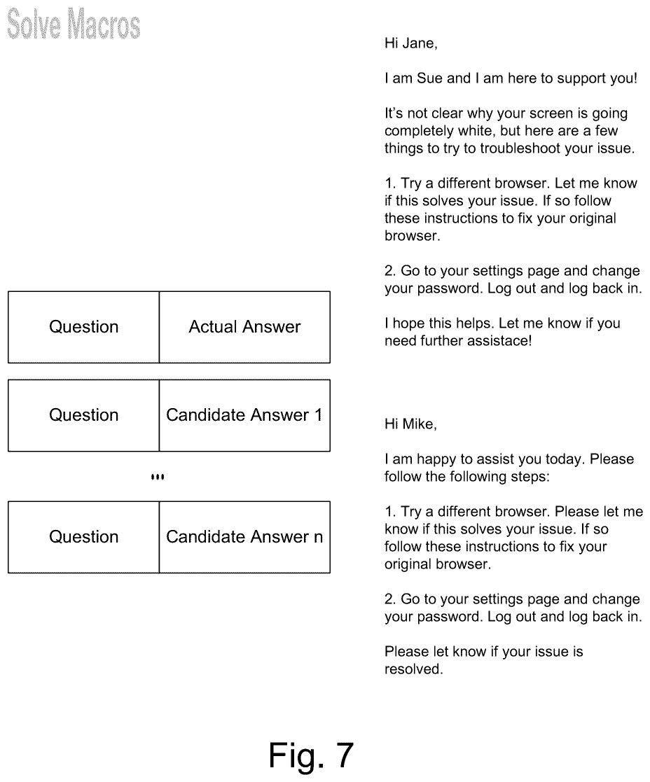

FIG. 7 illustrates an example of how the Solve Module uses weakly supervised learning. On the right are two answers that are variations upon a macro pre-approved answer. In this example, the language for trying a different browser and going to a settings page to change a password are minor variations of each other, with only minor changes, indicative of them having been originally generated from template language. Other portions of the answer are quite different. In any case, a dataset of questions and answers based on macros may be generated and supervised learning techniques used to automatically respond to a variety of common questions.

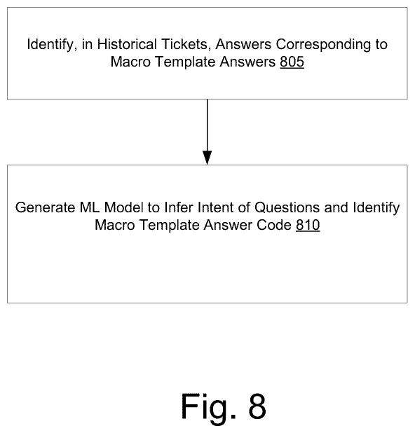

FIG. 8 is a flow chart of a high-level method to generate a ML classification model to infer intent of a customer question. In block 805, historical tickets are analyzed. Answers corresponding to variations on template macro answers are identified, such as by using common subsequence analysis techniques. In block 810, supervised learning may be performed to generate a ML model to infer intent of customer question and automatically identify a macro template answer code to respond to a new question.

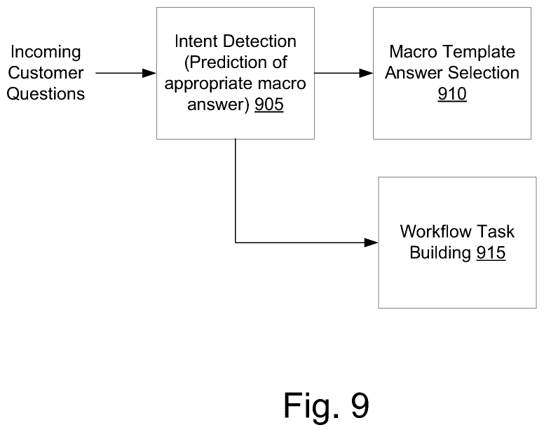

FIG. 9 illustrates a method of automatically selecting a template answer and workflow task building. In block 905, intent is inferred from a question, such as by using a classifier to generate a macro code, which is then used by another answer selection module 910 to generate a response.

For example, a macro code may correspond to a code for generating template text about a refund policy or a confirmation that a refund will be made. In this case, the template answer may be to provide details on requesting a refund or providing a response that refund will be granted. In some implementations, a workflow task building module 915 may use the macro code to trigger a workflow action, such as issuing a customer survey to solicit customer feedback, scheduling follow-up workflow actions, such as scheduling a refund, follow-up call, etc.

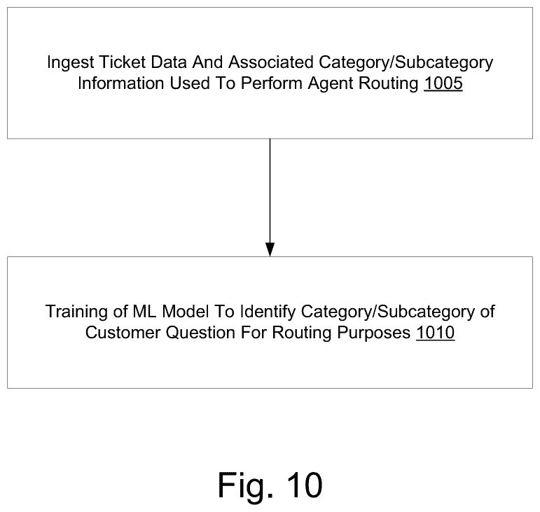

FIG. 10 is a high-level flow chart of a method of training a ML classifier model to identify a category/subcategory of a customer question to perform routing of tickets to agents. In block 1005, historic ticket is ingested, which may include manually labelled category/subcategory routing information, as well as a priority level. In block 1010, a ML model is trained to identify category/subcategory of a customer question for routing purposes. This may include, for example, identifying a category/subcategory for identifying an escalation category/subcategory. For example, a customer may be complaining about a repeat problem, or that they want a refund, or that customer service is no good, etc. A ticket corresponding to an escalation risk may be routed to a human agent with training or experience in handling escalation risks. In some implementations, an escalation risk is predicted based in part on other data, such as customer survey data as previously discussed. More generally, escalation risk can be predicted using a model that prioritizes tickets based on past escalations and ticket priority, with customer survey data being still yet another source of data used to train the model.

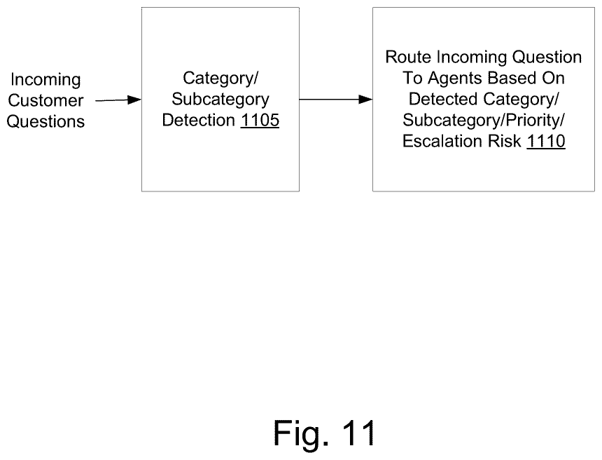

As illustrated in FIG. 11, incoming tickets may be analyzed using the trained ML model to detect category/subcategory/priority in block 1105 and route 1110 a ticket to an agent based on the detected category/subcategory/priority. The routing may, for example, be based in part on the training and skills of human agents. For example, the category/subcategory may indicate that some agents are more capable of handling the question than other agents. For example, if there is indication of an escalation risk, the ticket may be routed to an agent with training and/or experience to handle escalation risk, such as a manager or a supervisor.

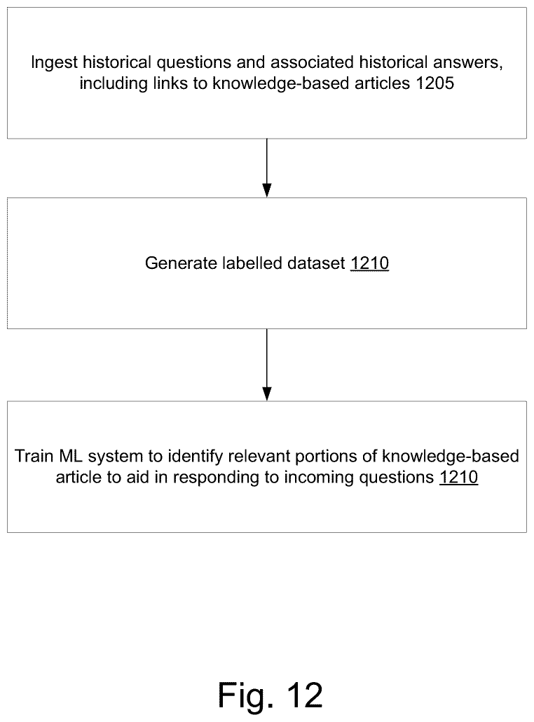

FIG. 12 is a flow chart of a method of training a ML model to generate a ML classifier. In block 1205, historical questions and historical answers are ingested, including links to a knowledge-based article. In block 1210, a labelled dataset is generated. In block 1215, the ML is trained to generate answers to incoming questions, which may include identifying relevant portions of knowledge-based answers.

Additional Examples of Intent Detection for Solve Module and Workflows

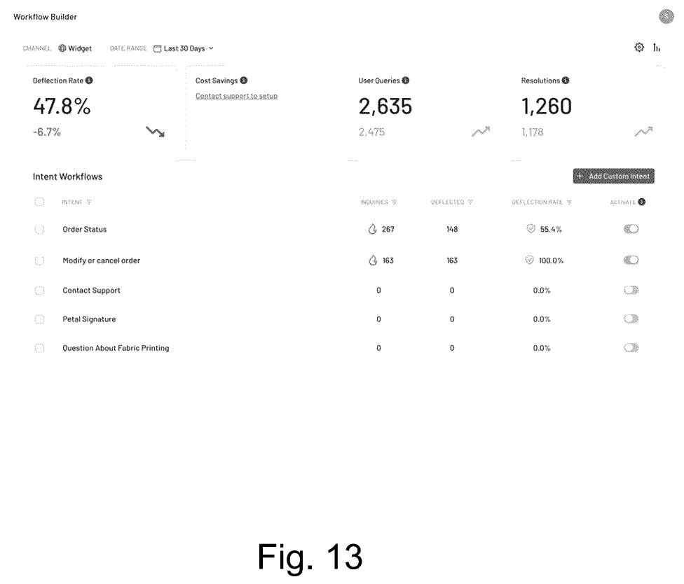

Referring to FIG. 13, in one implementation, custom intents can be defined and intent workflows created in a workflow builder. In the example of FIG. 13, intent workflows are illustrated for order status, modify or cancel order, contact support, petal signature question, and question about fabric printing. But more generally, custom intent workflows may be defined using the workflow builder, which is an extension of the Solve module.

As previously discussed, In some implementations, a support manager may configure specific workflows. In one implementation, a support manager can configure workflows in Solve, where each workflow corresponds to a custom “intent.” An example of an intent is a refund request, or a reset password request, or a very granular intent such as a very specific customer question. These intents can be defined by the support admin/manager, who also configures the steps that the Solve module should perform to handle each intent. The group of steps that handle a specific intent are called a workflow. When a customer query comes in, determines with a high degree of accuracy which intent (if any) this query corresponds to, and if there is one, triggers the corresponding workflow (i.e., a sequence of steps).

Automatic Generation of Granular Taxonomy

Conventionally, a company manually selects a taxonomy for categories/subcategories in regard to ticket topics of a customer support system. This typically results in a modest number of categories/categories, often no more than 15. Manually selecting more than about 20 categories also raises challenges training support agents to recognize and accurately label every incoming ticket.

In one implementation, the discovery module 225 includes a classifier trained to identify a granular taxonomy of issues customers are contacting a company about. The taxonomy corresponds to a set of the topics of customer issues.

As an illustrative example, customer support tickets may be ingested and used to identify a granular taxonomy. The total number of ingested customer support tickets may, for example, correspond to a sample size statistically likely to include a wide range of examples of different customer support issues (e.g., 50,000 to 10,000,000 customer support tickets). This may, for example, correspond to ingesting support tickets over a certain number of months (e,g., one month, three months, six months, etc.). There is a tradeoff between recency (ingesting recent tickets to adapt the taxonomy to new customer issues), the total number of ingested support tickets (which is a factor in the number of taxonomy topics that are likely to be generated in the taxonomy), and other factors (e.g., the number of different products, product versions, software features, etc. of a company). But as an illustrative example, a granular taxonomy may be generated with 20 or more topics corresponding to different customer support issue categories. In some cases, the granular taxonomy may be generated with 50 or more topics. In some cases, the granular taxonomy may include up to 200 or more different issue categories.

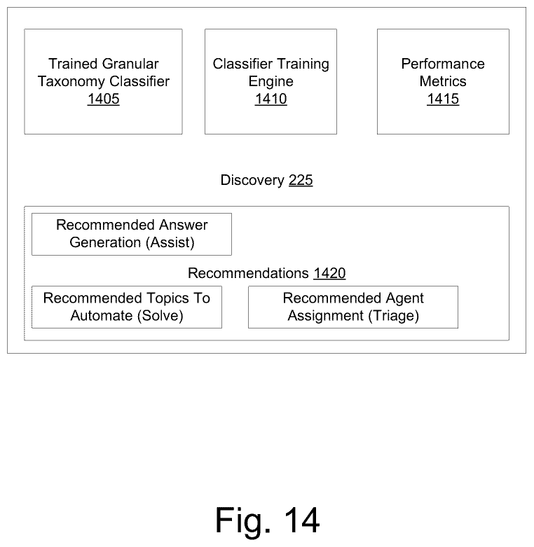

Referring to FIG. 14, in one implementation the discovery module includes a trained granular taxonomy classifier 1405. A classifier training engine 1410 is provided to train/retrain the granular taxonomy classifier. In some implementations, the granular taxonomy classifier 1405 is frequently retrained to aid in identifying new emerging customer support issues. For example, the retraining could be done on a quarterly basis, a monthly basis, a weekly basis, a daily basis, or even on demand.

In one implementation, a performance metrics module 1415 is provided to generate various metrics based on a granular analysis of the topics in customer support tickets, as will be discussed below in more detail. Some examples of performance metrics include CSAT (Customer Satisfaction Score), time to resolution, time to first response, etc. For example, the performance metrics may be used to generate a user interface (UI) to display customer support issue topics and associated performance metrics. Providing information at a granular level on customer support issue topics and associated performance metrics provides valuable intelligence to customer support managers. For example, trends in the performance metrics of different topics may provide actionable clues and suggest actions. For example, a topic indicating a particular problem with a product release may emerge after the product release and an increase in the percentage or volume of such ticket may generate a customer support issue for which an action step could be performed, such as alerting product teams, training human agents on how to handle such tickets, generating recommended answers for agents, or automating responses to such tickets.

In one implementation, a recommendations module 1420 is provided to generate various types of recommendations based on the granular taxonomy. As some examples, recommendations may be generated on recommended answers to be provided to agents handling specific topics in the granular taxonomy. For example, previous answers given by agents for a topic in the granular taxonomy may be used to generate a recommended answer when an incoming customer support ticket is handled by an agent. Recommendations of topics to be automatically answered may be provided. For example, in one implementation, the granular taxonomy is used to identify topics that were not previously provided with automated answers. In one implementation, recommendations are provided to consider updating the assignment of agents to topics when new topics are identified.

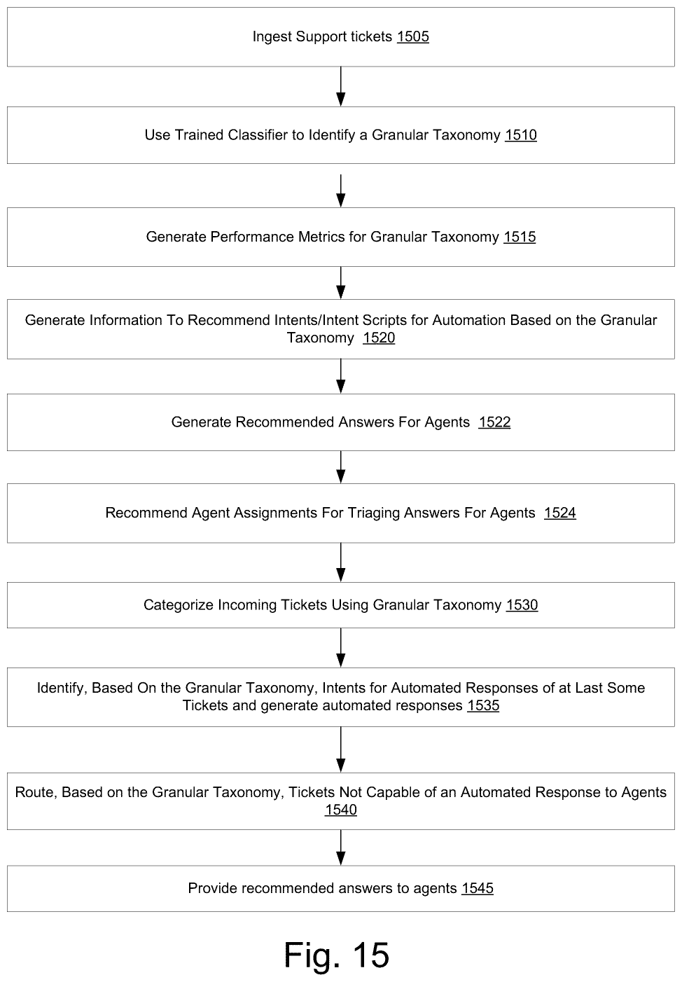

FIG. 15 is a flow chart of an example method of using the trained classifier in accordance with an implementation. In block 1505, support tickets are ingested. In this example, the classifier has been previously trained, so in block 1510 the trained classifier is used to identify and classify customer support tickets in regard to individual tickets having a topic in the granular taxonomy (e.g., for example, 50 to 200 or more topics in a granular taxonomy). The classification may be against a set of thresholds, e.g., a positive classification made for a value exceeding a threshold value corresponding to a pre-selected confidence value.

As an implementation detail, the order of some of the following steps may vary from that illustrated. However, as an illustrative example, in block 1515, performance metrics are generated based on the granular taxonomy. For example, if the granular taxonomy has a large number of topics (e.g., 50 or more topics, such as for example 100 topics, 200 topics, etc.), statistics and performance metrics may be calculated for each topic and optionally displayed in a UI or in a dashboard. The statistics and performance metrics may also be used in a variety of different ways.

In block 1520, information is generated to recommend intents/intent scripts based on the granular taxonomy. As one of many possibilities, a dashboard may display statistics or performance metrics on topics not yet set up to generate automatic responses (e.g., using the Solve module). Information may be generated indicating which topics are the highest priority for generating scripts for automatic responses.

Another possibility, as illustrated in block 1522 is to generate a recommended answer for agents. The generation of recommended answers could be done in a setup-phase. For example, when an agent handles a ticket for a particular topic, based on previous agent answers for the same topic may be provided using, for example, the Assist module. Alternatively, recommended answers could be generated on demand in response to an examiner handling a customer support ticket for a particular topic.

In some implementations, a manager (or other responsible person) is provided with a user interface to permit them to assign particular agents to handle customer support tickets for particular topics. In some implementations, information on customer support topics is used to identify agents to handle particular topics. For example, if a new topic corresponds to customers having problems with using a particular software application or social media application on a new computer, a decision could be made to assign that topic to a queue handled by an agent having relevant expertise. As another example, if customer support tickets for a particular topic have bad CSAT scores, that topic could be assigned to more experienced agents. Having granular information on customer support ticket topics, statistics, and performance metrics permits a better assignment to be made of agents to handle particular topics. In some implementations, a manager (or other responsible person) could manually assign agents to particular topics using a user interface. However, referring to block 1524, alternatively, a user interface could recommend assignment for particular topics based on factors such as the CSAT scores or other metrics for particular topics.

Blocks 1530, 1535, 1540, and 1545 deal with responding to incoming customer support tickets using the granular taxonomy. In block 1530, incoming tickets are categorized using the granular taxonomy. For example, the trained classifier may have pre-selected thresholds for classifying an incoming customer support ticket into a particular topic of the taxonomy. As illustrated in block 1535, the intents of at least some individual tickets are determined based on the topic of the ticket, and automated responses are generated.

As illustrated in block 1540, remaining tickets not capable of an automated response may be routed to individual agents. In some implementations, at least some of these tickets are routed to agents based on topics in the granular taxonomy. For example, some agents may handle tickets for certain topics based on subject matter experience or other factors. In block 1545, recommended answers are provided to individual agents based on previous answers to tickets for the same topic. The recommended answers may be generated in different ways. For example, the recommended answer may be generated based on the text of previous answers. In one implementation, a model generates a recommended response answer based on the text of all the agent answers in previous tickets. Alternatively, an algorithm may be used to generate a recommended answer by picking a previous answer to a topic that is most likely to be representative. For example, answers to particular topics may be represented in a higher dimensional space. In one implementation, tickets most like each other (close together in a higher dimensional space) are deemed to be representative.

Examples of training of the classifier will now be described. Manual (human) labelling of tickets is theoretically possible but is time consuming, costly, and complicated when there is a large number of known topics. However, one of the issues in generating a granular taxonomy is that the taxonomy needs to be discovered as part of the process of training the classifier. Customer support tickets may include emails, chats, and other information that is unstructured text generated asynchronously. For example, in one implementation a customer support chat UI includes a general subject field and unstructured text field for a customer to enter their question and initiate a chat with an agent. An individual customer support ticket may be comparatively long in the sense of having rambling run on sentences (or voice turned into text for a phone interaction) before the customer gets to the point. An angry customer seeking support may even rant before getting to the point. An individual ticket may ramble and have a lot of irrelevant content. It may also have repetitive or redundant content.

Additionally, in some cases, a portion of a customer support ticket may include template language or automatically generated language that is irrelevant for generating information to train the classifier. For example, the sequence of interactions in a customer support ticket may include template language or automatically generated language (e.g., as an example an agent may suggest a template answer to a customer (e.g., “Did you try rebooting your computer?) with each agent using slight variations in language (e.g., “Hi Dolores. Have you tried rebooting your computer?”). However, this template answer might not work, and there may be other interactions with the customer before the customer's issue is resolved. As another example, an automated response may be provided to a customer (e.g., “Have you checked that you upgraded to at least version 4.1?”). However, if the automated response fails, there may be more interactions with the client.

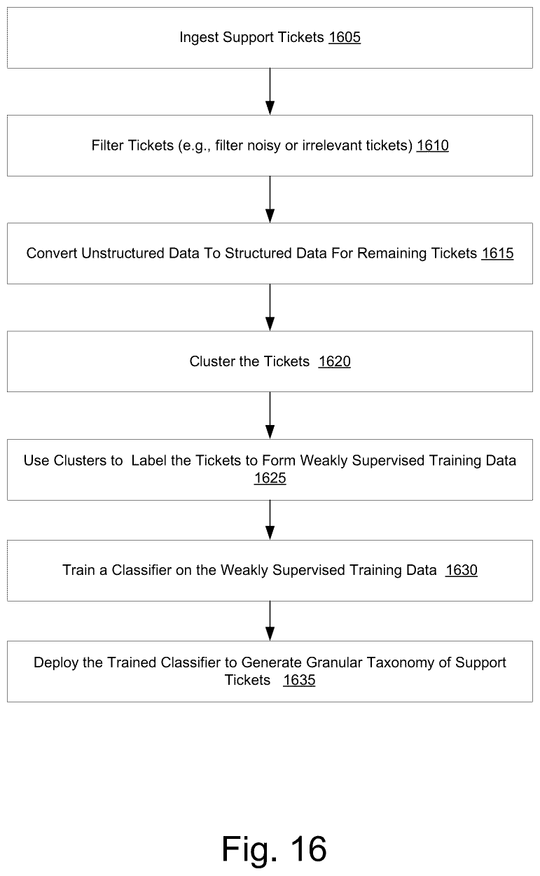

FIG. 16 is a flow chart of an example method of training the classifier according to an implementation. In block 1605, support tickets are ingested. As previously discussed this may be a number of support tickets selected to be sufficiently large for training purposes, such as historical tickets over a selected time period. In block 1610 the ingested support tickets are filtered. The filtering may, for example, filter noisy portions of ticket or otherwise filter irrelevant tickets. This may include filtering out template answers and automated sections of tickets. More generally, the filtering may include other types of filtering to filter out text that is noise or otherwise filter irrelevant data.

In block 1615, the unstructured data of each ticket is converted to structured (or at least semi-structured) data. For example, in one implementation, one or more rules is applied to structure the data of the remaining tickets. For example, individual customers may use different word orders and different words for the same problem. An individual customer may use different length sentences to describe the same product and problem, with some customers using long rambling run-on sentences. The conversion of the unstructured text data to structured text data may also identify the portion of the text most likely to be the customer's problem. Thus, for example, a long rambling unstructured rant by a customer is converted into structured data identifying the most likely real problem the customer had. In one implementation, a rule is applied to identify and standardize the manner in which a subject, or a short description, or a summary is presented.

Applying one or more structuring rules to the ticket data results in greater standardization and uniformity in the use of language, format, and length of ticket data for each ticket, which facilitates later clustering of the tickets. This conversion of the unstructured text data into structured text may use any known algorithm, model, or machine learning technique to convert unstructured text into structured (or semi-structured) text that can be clustered in the later clustering step of the process.

In block 1620, the ticket data that was structured data is clustered. The clustering algorithm may include a rule or an algorithm to assign a text description to the cluster. In block 1625, the clusters are used to label the customer support tickets to generate weakly supervised training data to train the classifier. In block 1630, the classifier is trained based on the weakly supervised training data. In block 1635, the trained classifier is deployed and used to generate the granular taxonomy of the customer support tickets.

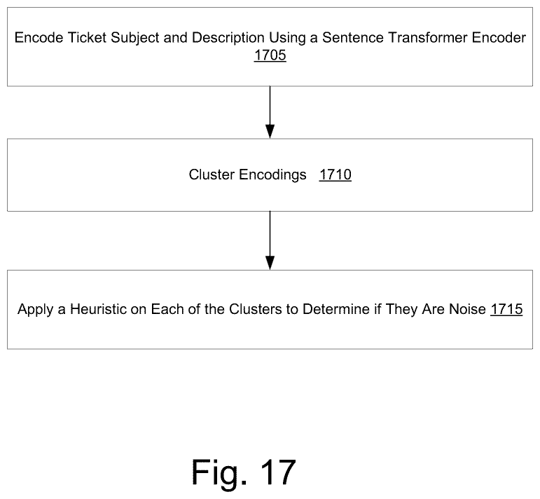

FIG. 17 is a flow chart of an example method of filtering to filter out noise and irrelevant text, which may include text from template answers and automated answers. In block 1705, the ticket subject and description are encoded using a sentence transformer encoder. In block 1710, the encodings are clustered. For example, a DBSCAN (Density based Spatial Clustering Of Applications With Noise) may be used. In block 1715, a heuristic is applied on the clusters to determine if they are noise. For example, a heuristic may determine if more than a pre-selected percentage of the text is overlapping between all the pairs of tickets in the cluster. In one implementation, a high percentage (e.g., over a threshold values, such as 70%) is indicative of noise (e.g., text generated from a common template answer). However, other heuristic rules could be applied. The noisy clusters are then removed. That is, the end result of the filtering process may include removing ticket data corresponding to the noisy clusters.

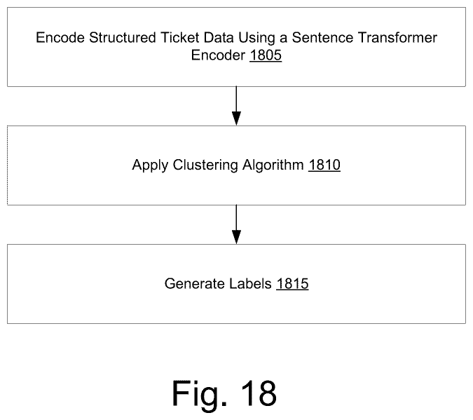

A variety of clustering techniques may be used to perform the step 1620 of clustering the tickets in FIG. 16. This may include a variety of different clustering algorithms, such as k-means clustering. Another option is agglomerative clustering to create a hierarchy of clusters. In one implementation, DBSCAN is used to perform step 1620. Referring to the flow chart of FIG. 18, in one implementation, in block 1805, the structured ticket data is encoded using a sentence transformer. In block 1810, a clustering algorithm is applied, such as DBSCAN. The name of the cluster may be based on a most common summary generated for that cluster. A variety of optimizations may optionally be performed. For example, some of the same issues may be initially clustered in separate but similar clusters. A merger process may be performed to merge similar clusters, such as by performing another run of DB SCAN with looser distance parameter and merging clusters together to obtain a final clustering/labeling to generate labels, as illustrated in block 1815.

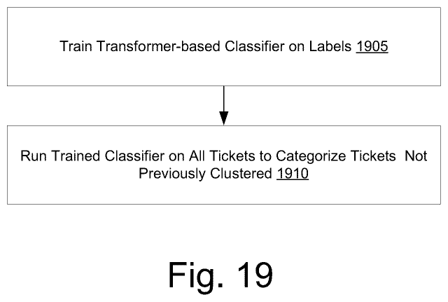

FIG. 19 is a flow chart illustrating in block 1905 training the transform based on labels generated from the clustering process. In one implementation, the classifier is a transformer-based classifier, such as RoBERTA or XLNet. In block 1910, the classifier is run on all tickets to categorize at least some of the tickets that were not successfully clustered.

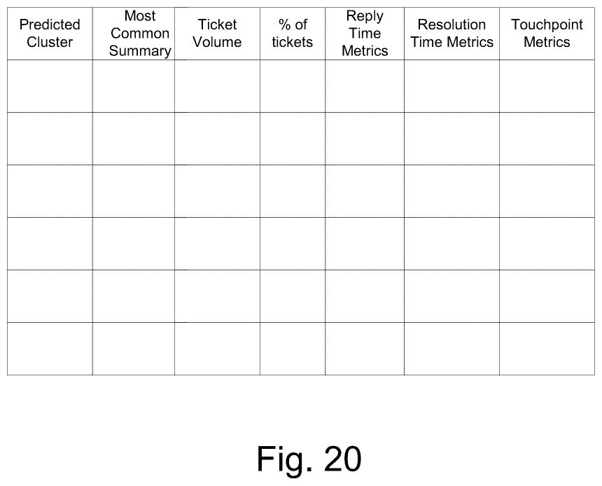

A variety of dashboards and UIs may be supported. FIG. 20 illustrates an example of performance metric fields. Each topic may correspond to a predicted cluster. Summary information, ticket volume information, % of tickets, reply time metrics, resolution time metrics, and touchpoint metrics are examples of the types of performance metrics that may be provided.

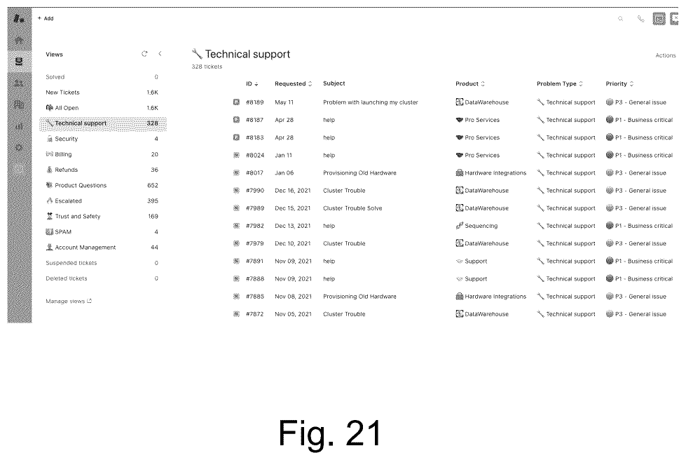

FIG. 21 illustrates a pull queue UI in which agents pull tickets based on subject, product, problem type, and priority (e.g., P1, P2, P3). Agents may also be instructed to pick up tickets in specific queues. Push (not shown) occurs when tickets are assigned to agents through an API based on factors such as an agent's skills, experience, and previous tickets they have resolved.

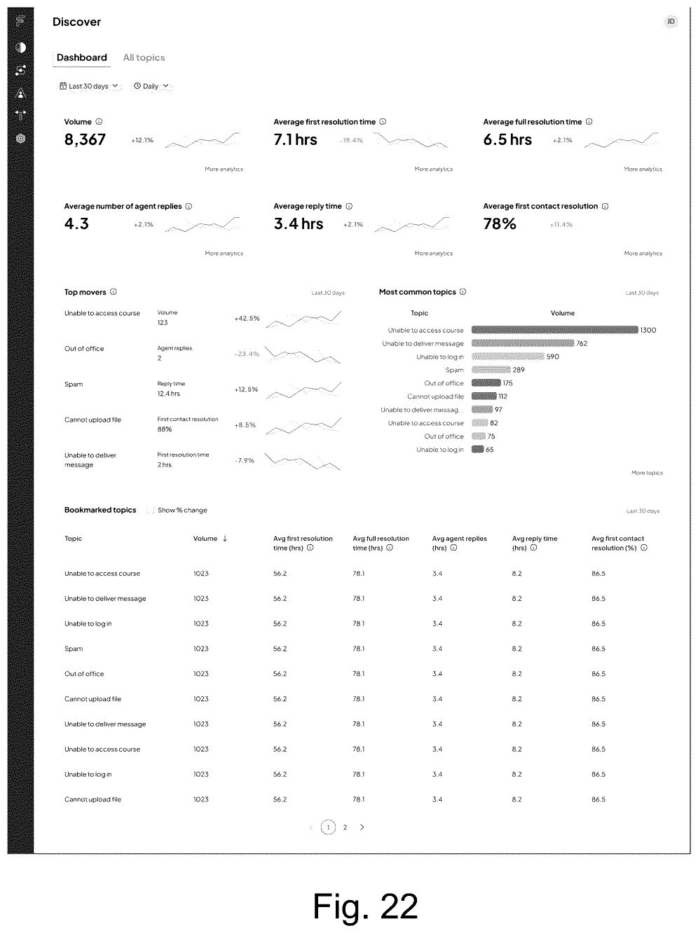

FIG. 22 illustrates a dashboard. The dashboard in this example shows statistics and metrics regarding tickets, such as ticket volume, average number of agent replies, average first resolution time, average reply time, average full resolution time, and average first contact resolution. As other examples, the dashboard may show top movers in terms of ticket topics (e.g., “unable to access course”, “out of office”, “spam”, “cannot upload file”, etc.). As another example, bar chart or other graph of most common topics may be displayed. As yet another example, bookmarked topics may be displayed.

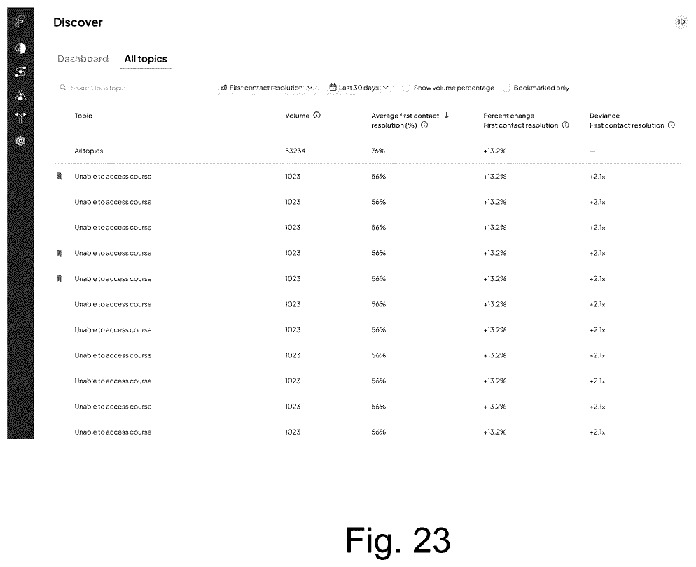

FIG. 23 shows a UI display a list of all topics and metrics such as volume, average first contact resolution, percent change resolution, percent change first contact resolution, and deviance first contact resolution.

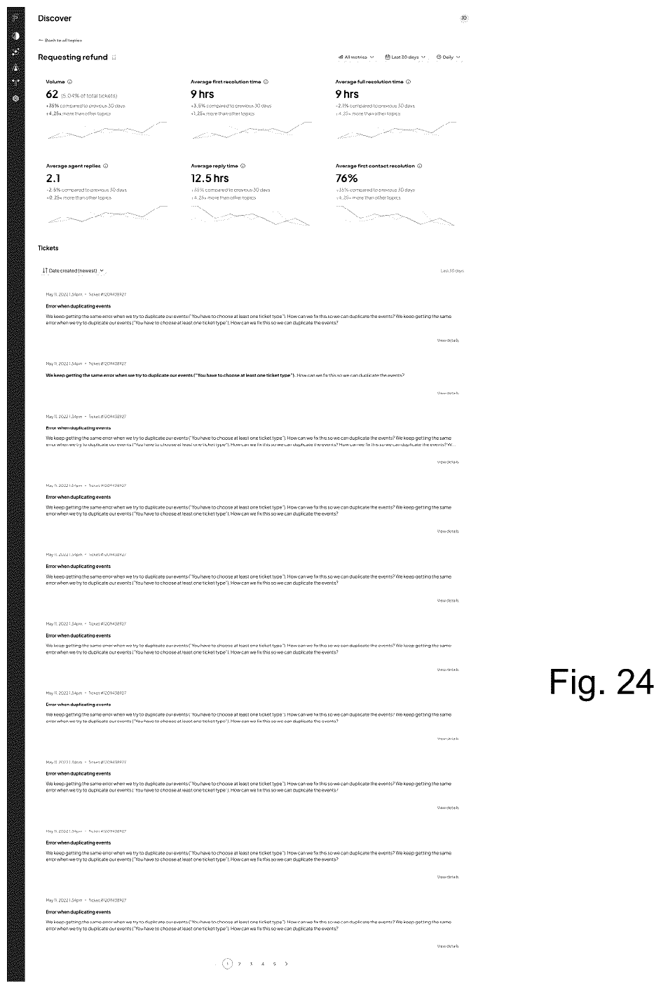

FIG. 24 illustrates a UI showing metrics for a particular topic (e.g., “requesting refund”). Information on example tickets for particular topics may also be displayed.

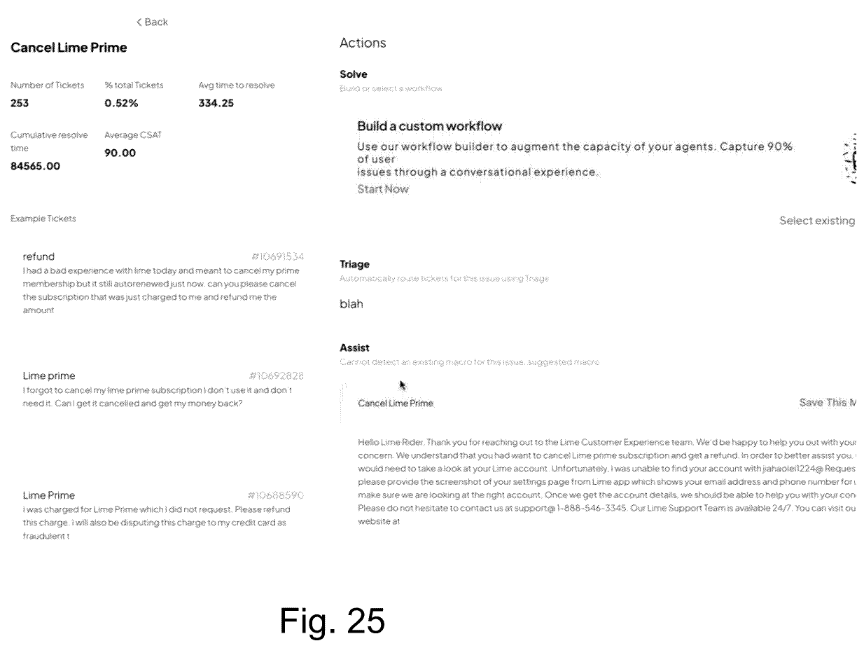

FIG. 25 illustrates a UI having an actions section to build a custom workflow for solve, customizing triage, and generating suggested answers for assist.

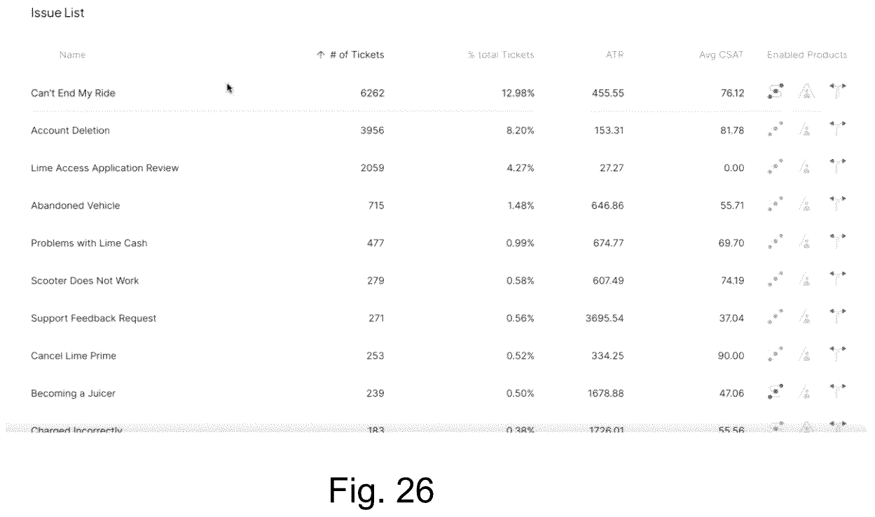

FIG. 26 shows a UI having an issue list and metrics such as number of tickets, percentage of total tickets, average time to response, and average CSAT.

While several examples of labeling have been described, more generally multi-labels could also be used for the situation of tickets representing multiple issues.

In some implementations, periodicity retraining of the classifier is performed to aid in picking up on dynamic trends.

While some user interfaces have been described more generally, other user interfaces could be included to support automation of the process of going from topics to determining intents from the topics to automating aspects of providing customer support.

### Alternate Embodiments

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware. Moreover, the technologies disclosed above are primarily in the context of flash arrays. However, the disclosed technologies apply to other data storage devices.

Reference in the specification to “one embodiment”, “some embodiments” or “an embodiment” means that a particular feature, structure, or characteristic described in connection with the embodiment is included in at least some embodiments of the disclosed technologies. The appearances of the phrase “in some embodiments” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms, for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer.

The disclosed technologies can take the form of an entirely hardware implementation, an entirely software implementation or an implementation containing both software and hardware elements. In some implementations, the technology is implemented in software, which includes, but is not limited to, firmware, resident software, microcode, etc.

Furthermore, the disclosed technologies can take the form of a computer program product accessible from a non-transitory computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A computer-implemented method of augmenting customer support, comprising:
ingesting customer support tickets associated with a helpdesk;
filtering the customer support tickets to filter at least one of noisy and irrelevant tickets;
for the filtered customer support tickets, converting unstructured ticket data to structured data to form tickets with structured data;
clustering the customer support tickets with structured data;
utilizing the clusters to label the customer support tickets to form a weakly supervised training data; and
training a classifier, on the weakly supervised training data, to classify customer support tickets into topics of a granular taxonomy.

2. A computer-implemented method of augmenting customer support, comprising:
ingesting customer support tickets associated with a helpdesk;
generating training data, from the customer support tickets, to identify a taxonomy of customer support topics; and
training a classifier to generate a trained classifier to classify customer support tickets into topics of the taxonomy.

3. The computer-implemented method of claim 2, wherein the generating training data comprises converting unstructured customer support ticket data into structured ticket data.

4. The computer-implemented method of claim 3, further comprising clustering the structured ticket data to generate labels and the generating training data includes labelling the customer support tickets.

5. The computer-implemented method of claim 4, wherein the clustering comprises at least one of k-means clustering, agglomerative clustering, and Density based Spatial Clustering Of Applications With Noise.

6. The computer-implemented method of claim 2, wherein the method further comprises filtering noise and irrelevant data from the customer support tickets.

7. The computer-implemented method of claim 6, wherein the filtering comprises identifying and removing template answers within customer support tickets.

8. The computer-implemented method of claim 6, wherein the filtering comprises identifying and removing automatically generated answers within customer support tickets.

9. The computer-implemented method of claim 2, further comprising using the trained classifier to generate recommendations for automating answers to at least one topic in the taxonomy.

10. The computer-implemented method of claim 2, further comprising generating a recommended answer for a human agent to respond to a topic in the taxonomy.

11. The computer-implemented method of claim 2, further comprising assigning agents to handle customer support tickets for particular topics in the taxonomy.

12. The computer-implemented method of claim 2, further comprising generating a user interface displaying metrics of customer support tickets based on topics in the taxonomy.

13. A computer-implemented method of augmenting customer support, comprising:
receiving customer support tickets associated with a helpdesk;
classifying, using a trained classifier, received customer support tickets into a granular taxonomy of customer support ticket topics to identify customer support topics for at least some of the received customer support tickets, wherein, the granular taxonomy is generated from a set of previous customer support tickets; and
generating a user interface display of customer support ticket information based on topics determined by the classifying.

14. The computer-implemented method of claim 13, where the user interface display includes performance metrics for particular ticket topics.

15. The computer-implemented method of claim 13, wherein the user interface display comprises recommendations for automating responses for at least one customer support topic.

16. The computer-implemented method of claim 13, wherein the taxonomy includes at least 20 customer support topics.

17. A computer-implemented method of augmenting customer support, comprising:
receiving customer support tickets associated with a helpdesk;
classifying, using a trained classifier, received customer support tickets into a granular taxonomy of customer support ticket topics to identify customer support topics for at least some of the received customer support tickets, wherein, the granular taxonomy is generated from a set of previous customer support tickets; and
automatically generating information to respond to a customer support ticket based on the customer support topic.

18. The computer-implemented method of claim 17, wherein automatically generating information comprise generating an automatic answer to the customer support ticket.

19. The computer-implemented method of claim 17, wherein automatically generating information comprise generating a recommended answer for a human agent handling the customer support ticket.

20. The computer-implemented method of claim 17, wherein the taxonomy includes at least twenty customer support topics.

21. A computer-implemented method of augmenting customer support, comprising:
receiving customer support tickets associated with a helpdesk;
discovering a granular taxonomy of the customer support ticket, wherein the granular taxonomy is generated from a set of previous customer support tickets including:
1) ingesting customer support tickets associated with a helpdesk;
2) filtering the customer support tickets to filter at least one of noisy and irrelevant tickets;
3) for the filtered customer support tickets, converting unstructured ticket data to structured data to form tickets with structured data;
4) clustering the customer support tickets with structured data;
5) utilizing the clusters to label the tickets to form a weakly supervised training data; and
6) training a classifier, on the weakly supervised training data, to classify customer support tickets into topics of a granular taxonomy;
generating performance metrics for topics in the granular taxonomy;
recommending topics in the granular taxonomy for generation of automatic responses; and
in response to a user input, automating response to at least one recommended topic.
